(19) United States
(12) Patent Application Publication
(10) Pub. No.: US 2012/0278094 A1
(43) Pub. Date: Nov. 1, 2012

(54) METHODS AND SYSTEMS FOR HEALTH CARE RECORD, WORKFLOW, AND BILLING MANAGEMENT USING MOBILE DEVICES

(75) Inventors: Srdjan N. Kovacevic, San Diego, CA (US); John Robert Ward, Pittsburgh, PA (US)

(73) Assignee: Rabit Solutions, LLC, Pittsburgh, PA (US)

(21) Appl. No.: 13/272,182

(22) Filed: Oct. 12, 2011

Related U.S. Application Data
(60) Provisional application No. 61/392,041, filed on Oct. 12, 2010.

(51) Int. Cl. G06Q 50/22; G06F 15/16

(52) U.S. Cl. 705/2; 709/203

(57) ABSTRACT

The present invention relates to health care, and more particularly to a dynamic and mobile platform for providing comprehensive health care record and workflow management, including management of medical billing, that can be configured for healthcare professionals who do not necessarily practice from a single location, and may practice frequently from locations outside of their primary practice location. The technology provides a health care data capture, analysis and user interface solution that simplifies and expedites the billing procedure for healthcare professionals. Additionally, the technology described herein supports healthcare professionals who may work as a team, and need to communicate and collaborate with each other while rendering their services.

### CROSS-REFERENCE TO RELATED APPLICATIONS

The present application claims priority from, U.S. Prov. Appln. No. 61/392,041, filed Oct. 12, 2010, the contents of which are incorporated herein by reference in their entirety.

### FIELD OF THE INVENTION

The present invention relates to health care, and more particularly to a dynamic and mobile platform for providing comprehensive health care record and workflow management, including management of medical billing, that can be configured for healthcare professionals who may need to bill for services provided outside of their primary practice location, and who may work as a team, and need to communicate and collaborate with each other while rendering their services.

### BACKGROUND OF THE INVENTION

Many attempts at computerizing various health care information have been made, such as, computer-based hospital systems and networks for providing patient care. There are existing patient record-keeping systems and billing systems, that are fully or at least partly computerized. If computerized health care records are properly coded, the record keeping and billing processing efficiency of the existing systems can improve dramatically, as in many cases efficient data processing is directly impacted by compliance with acceptable codes.

Simplified record keeping and billing management procedures impact the bottom line of health care practice provided by a small team of healthcare professionals or a solo practitioner. Many healthcare professionals are rendering their services at various locations, rather than being tied to their primary location of practice. For them, it would be desirable to streamline and simplify data capture and data utilization for billing and other record management purposes.

The present inventors have recognized a profound need for a comprehensive solution that meets the demands of healthcare providers for aggregation of relevant data from a broad base of internal and external data resources when and where they need it, including locations outside of their primary practice location. Such a comprehensive system would preferably provide alignment with the existing and evolving standards, making interfacing with external components and services intuitive, convenient, and seamless. With the computational power of mobile devices increasing steadily, there is a huge potential for using mobile devices, such as, smartphones, personal digital assistants (PDA), notebook computers, laptop computers, or other handheld devices, as a front-end for health care record and billing management, while the mobile device has a dynamic communication established with back-end servers and data repositories.

### SUMMARY OF THE INVENTION

The present invention provides a dynamic platform with for health care record and workflow management, including management of medical billing, by utilizing categorically coded information. The technology provides a health care data capture, analysis and user interface solution that streamlines the plurality of procedures leading to billing. The platform includes back-end server components (e.g., office servers, cloud servers etc.) and front-end client components (including mobile clients) that optimize, simplify and expedite billing, thereby improving efficiency and maximizing revenue by helping to eliminate missed charges for rendered services, and shorten billing cycles. Additionally, the technology described herein supports healthcare professionals who may work as a team, and need to communicate and collaborate with each other while rendering their services. This way redundant work can be avoided, leading to further improvement in overall efficiency for a team of healthcare professionals. Using proper software and hardware combination, the platform herein can be configured for healthcare professionals who do not necessarily practice from a single location, and may practice frequently from locations outside of their primary practice location.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating high level view of various components and their interaction with external systems, according to an embodiment of the present invention;

FIG. 2 shows some components of a mobile client, according to an embodiment of the present invention;

FIG. 3 shows data elements and their relationships in the data model of the mobile client data storage, according to an embodiment of the present invention;

FIG. 4 shows a high-level task model in the mobile client, according to an embodiment of the present invention;

FIG. 5 shows an example embodiment (screen shot from a particular device) of log-in/authentication interface according to an aspect of the present invention;

FIGS. 6A-6B show example embodiments (screen shots from a particular device) of further interface options for coding and billing, according to aspects of the present invention;

FIG. 7 shows some components of an office server, according to an embodiment of the present invention;

FIG. 8 shows a high-level task model in the office server, according to an embodiment of the present invention;

FIG. 9 shows some components of a cloud server, according to an embodiment of the present invention; and

FIG. 10 shows an example illustration of a collaborative model, where multiple mobile clients can interact via a cloud server, according to an embodiment of the present invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration. Additionally, persons skilled in the art will readily recognize, in view of the following description, that the embodiments of the present invention can be implemented via software and hardware components, used in proper combination.

In general, the invention breaks new ground in the areas of health care workflow and billing management including expanded capabilities in the areas of data capturing, data aggregation from various sources, and alignment with existing systems and services. The invention incorporates a customizable and streamlined user interface that further simplifies data entry and analysis.

In the subsequent description, the term ‘healthcare professional’ encompass doctors, nurse practitioners, or any other qualified professional who provides medical service. The term may also include support staff for medical practitioners. The term ‘encounter’ generally describes a situation where a healthcare professional renders a service to a patient. Also, the terms ‘mobile device’ and ‘handheld device’ are used interchangeably.

### Overview

Accurate, on-time billing is extremely important for every healthcare professional. It requires preparing proper documentation and it can be difficult or time consuming especially in a location where there might not be support staff or office computers that can access/process required health care data. For instance, healthcare professionals who see their patients in a hospital, outside of their primary office, often have to carry around physical copies of information (such as, loose 3×5″ cards, billing sheets or scribbled notes) that are used for billing. These notes then need to be organized, copied and sent for billing periodically. In a busy day, they may not find time to do billing until few days later, delaying the reimbursement and increasing the possibility of lost notes, and increasing chances of forgotten billing.

Healthcare professionals using the invention described herein can avoid carrying physical notes. If they forget a billing code, they can look it up in the hand-held directory. Billing updates can be sent electronically to their hand-held device at the time of the encounter. Forgetting to bill, losing their physical notes, or late billing can be largely avoided due to the advantageous features of the present invention., as more rapid billing would lead to faster reimbursement for their practices.

The present inventors have invented a solution that enables healthcare professionals to better manage their workflow, and to simplify and speed up their billing by using mobile devices. One example of a system implementing such a solution is commercially named RABIT (Rapid Billing Technology), provided by Rabit Solutions of Pittsburg, Pa.

### High-Level Architecture

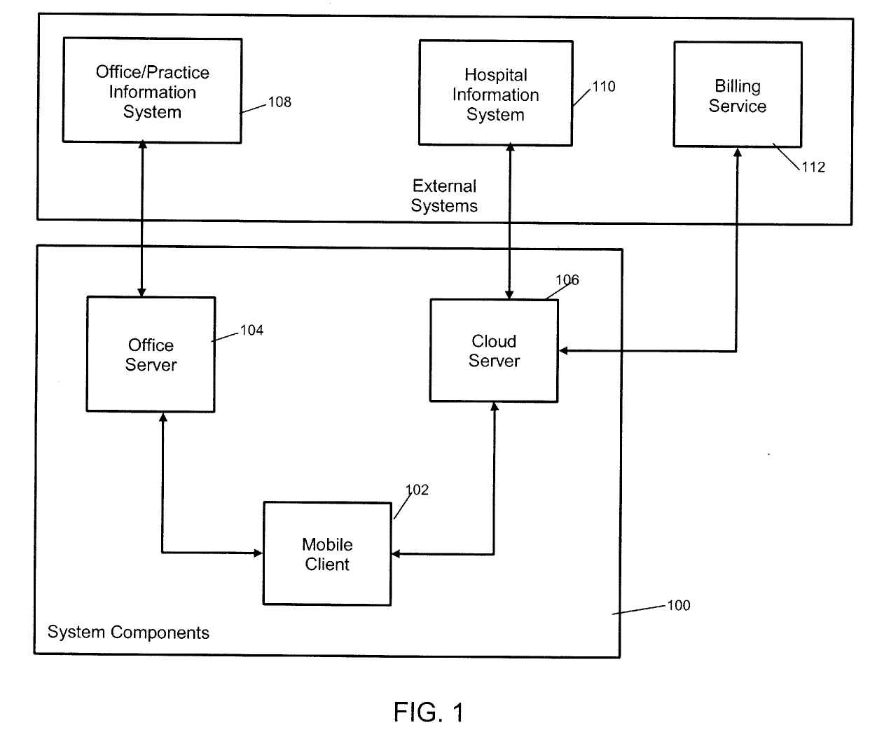

FIG. 1 shows high level view of components of an example system 100 of the present invention and the interaction with external systems. Three main components of the system 100 are a mobile client 102, an office server 104, and a cloud server 106. As will be appreciated by persons skilled in the art, FIG. 1 is a non-limiting example showing one instances of each components, where there may be multiple instances (physical or virtual) of each of the components 102, 104, and 106. Also, not all of the components have to be part of each embodiment. For example, a powerful mobile device may eliminate the need of a separate office server 104, and the office server functionalities may be handled by a server included in the mobile device. Also, instead of a mobile client, a web-based client can be used that runs in a computer. However, for illustrative purposes and for the sake of the reader's advantage, we stick to the terms ‘mobile client’, ‘office server’ and ‘cloud server’ in describing the example embodiments of the invention.

The Mobile Client 102 is installed on a handheld device. The handheld device preferably has some input means for data entry or data capture. In an example, the handheld device is equipped with a camera, although it can work with devices without a camera. On a handheld device with a camera (e.g., a smartphone with a high resolution camera), the mobile client knows how to scan patient bar-codes. The client can interpret barcode locally or it can send it to the Cloud Server for processing. Based on the barcode, the Mobile Client will retrieve relevant patient information from its local data store or, if not found there, from Cloud Server. The mobile client understands relevant billing, procedure and diagnosis codes and it communicates with the Cloud Server and/or Office Server to exchange relevant information and updates. Whether the client does local processing and whether it communicates with the Office Server or Cloud Server, the process of getting the relevant information is transparent to healthcare professionals., as they do not have to worry about the back-end communication and only have to familiarize themselves with the Mobile Client. The Mobile Client provides easy-to-use, simple, but efficient and intuitive user interface and hides complexity of the rest of the system.

Cloud Server gathers and stores all relevant data that the Mobile Clients may need. This information includes billing codes, procedural and diagnosis codes, as well as demographic (DMG) information for “active” patients. For example, “active” patients can be those patients seen in the last N days (where N can be configured), or patients scheduled to be seen in the next M days (where M can be configured). The Cloud Server component provides interfaces to external systems. Example of external systems are hospital information management systems (HIMS) 110, and Billing Systems 112. Office/Practice IMS is typically linked via Office Server, but an embodiment where the Cloud Server interfaces with the Office/Practice IMS is also possible. These can be third-party systems, or can be particular Office/Practice information management system (IMS) 108. Cloud Server may also provide services that may not be supported on a particular handheld where the Mobile Client is running, such as bar-code reader. For instance, Mobile Client can scan the patient barcode using handheld's camera. Typically, the Mobile Client will process the barcode locally, but if it fails (e.g., noisy image or a handheld without a compatible local barcode processing service), it can send the image to the Cloud Server and have it processed there. The Cloud Server can also provide other services, such as Billing Service or OCR (Optical Character Recognition) Service, as will be discussed in more details later.

Office Server interfaces with healthcare professionals' Office/Practice Information systems 108, e.g., EMR (Electronic Medical Records) system or PMS (Practice Management Systems) to gather patients demographic (DMG) information and appointment scheduling information. It then pushes this information to the Cloud Server. It also provides connectivity to the Mobile Client—it can sync up with the Mobile Client using wired connection (e.g., cradle or USB cable), or wireless connection (e.g., bluetooth or local wireless network etc.). If the Mobile Client cannot directly connect to the cloud for whatever reason (e.g., poor cell phone signal coverage and no wireless network available), it can be connected via Office Server (e.g., wired connection to the Office Server which then interfaces it to the Cloud Server).

System components interface with external information systems (such as Hospital Information Systems (HIS) and Office/Practice Information Systems) and Billing Systems. The information systems may be Electronic Medical Record (EMR) systems (also known as Electronic Health Record systems, or EHR), patient scheduling systems, or other systems containing demographic information about patient that may be required for billing purposes. Multiple instances of external systems may also exist.

The Cloud Server, may be deployed as single or multiple physical instances according to the scalability and availability requirements. The Cloud Server can be connected to many Mobile Clients and many Office Servers. Each Office Server can be connected to many Mobile Clients. Each Mobile Client is connected to the Cloud Server and one or more Office Servers. Typically, a Mobile client is connected to a single Office Server, but if is possible to connect to more than one if a healthcare professional belongs to multiple practices with different servers. Typically, there will be one (active) Mobile Client for each (active) healthcare professional/user. It is possible for a healthcare professional to have multiple devices, but only one of them will have a Mobile Client active at any given time. It is also possible that several healthcare professionals (e.g., from the same group) may share a single device, but only one of them will be using it at a given moment and only this (active) healthcare professional will have an active Mobile Client.

All communication between internal and external components is preferably secure to prevent unauthorized access to protected information.

### Mobile Client

The Mobile Client is installed on a handheld device, such as a smart phone or PDA (Personal Digital Assistant), but can also be used on laptop, notebook, or tablet computers (e.g., iPad). While the preferred embodiment of the system described herein includes a mobile client equipped with a camera or an alternate barcode reader, it can operate with mobile clients that do not have barcode reading capabilities, whether due to low light/noisy environment preventing effective barcode scan, a malfunctioning camera/barcode scanner, or absence of camera/barcode scanner.

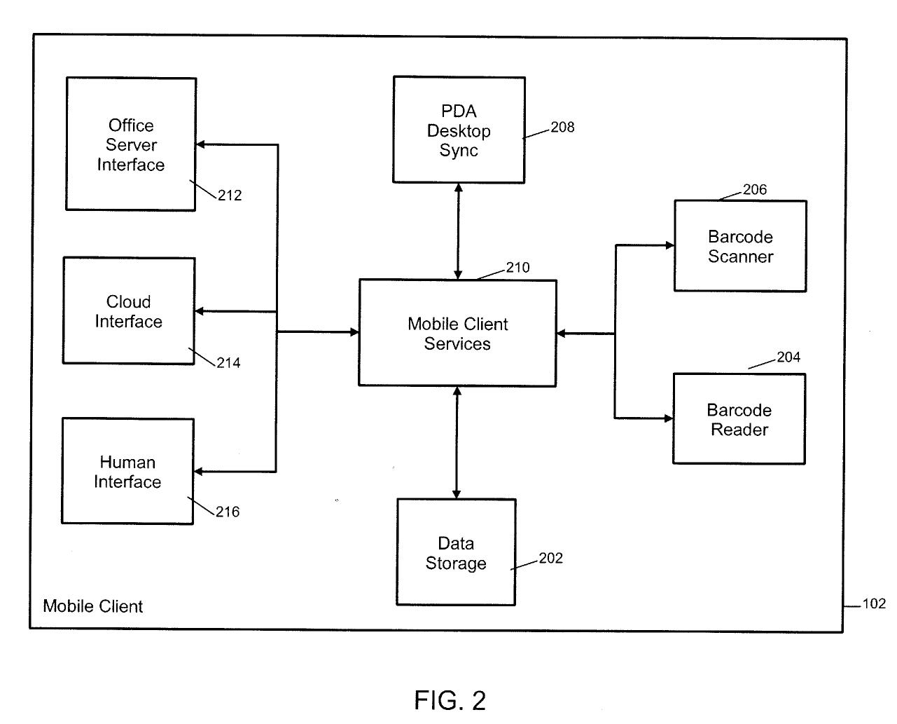

FIG. 2 shows main components of Mobile Client 102.

In the mobile client, data storage 202 is a local storage where the Mobile Client keeps information about active patients, relevant domain and specialty-specific information (such as diagnosis, procedure and billing codes), usage profile and user preferences etc. The Mobile Client Services 210 may include a barcode reader 204, a barcode scanner 206, a PDA/Desktop sync feature 208, an office server interface 212, a cloud interface 214, and a human interface 216, all of which are further explained below.

For all active patients, relevant DMG information required for billing is obtained from the corresponding Office Server or from the Cloud Server. The exact information may vary depending on a hospital information system and the billing procedures, e.g., whether to use Medical Record Number (MRN), Financial Identification Number (FIN), account number, or a different type of patient ID number. Typically, the DMG information required for billing includes a patient's name, address, date of birth, patient ID number etc.

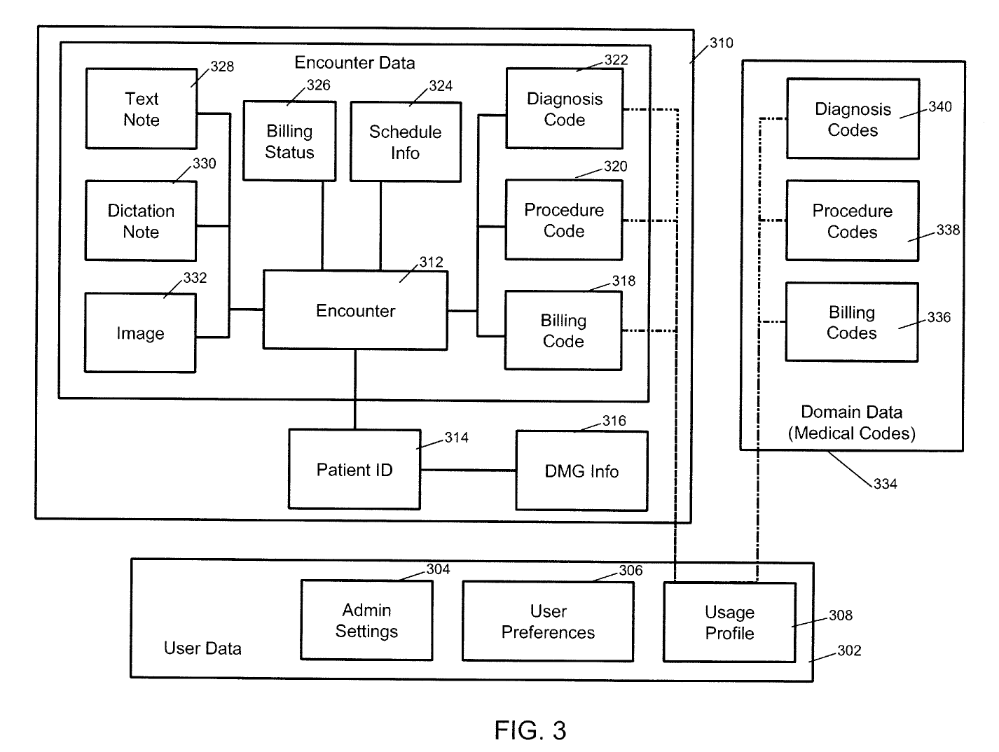

FIG. 3 shows various data element and their relationships in the data model of Mobile Client data storage. FIG. 3 shows various components of encounter data 310. A patient encounter 312 is associated with a number of inputs and codes.

Various medical codes are required for the workflow leading to final billing. Examples of codes are:

Diagnosis codes (322)—depending on a healthcare professional's specialty, a subset of diagnosis codes is downloaded to the mobile client.

Procedure codes (320)—depending on a healthcare professional's specialty, a subset of procedure codes is downloaded to the mobile client.

Billing codes (318)—depending on a healthcare professional's specialty, a subset of billing codes is downloaded to the mobile client.

In addition, the system allows other inputs. Examples are:

Text Notes (328)—any additional notes a healthcare professional makes to document a patient encounter are kept here.

Dictated Notes (330)—a healthcare professional can also dictate comments and observations as audio notes that are kept in the local data storage.

Images (322)—a healthcare professional can use a built in camera, if there is one, to take images (e.g., to document visual observations of a patient's condition) that are kept in the local data storage.

Additional inputs associated with the encounter may be billing status information (326) and schedule information (324).

Another option is accurate capturing and management of usage profile. Mobile Client keeps track of its usage (e.g., most frequently used codes in each category), in case a user (i.e., a healthcare professional using the Mobile Client) wants user interface optimized based on his/her patterns of use. (e.g., show most frequently used options first, or show most recently used options first). The optimization can also be context sensitive—correlate most frequently/recently used options with other values provided. For instance, in addition to capturing frequency of use of each billing code across all encounters, usage pattern can also capture how each billing code correlates to other medical codes and create frequency of use for each billing code in the context of other codes (e.g., diagnosis and procedure). This allows predictive modeling of how likely each code is based on already provided codes. The patterns can also capture information about billing codes that most often come as a group—the user interface (UI) can then be optimized to allow selecting them as a group instead of one by one.

User preferences and administrative settings—the data that controls configurable aspects of the system behavior and the Client's UI appearance are also kept in the local data storage.

It is possible to download and keep all medical codes (diagnosis, procedure and billing), depending on the client configuration and available memory, but that is not necessary as most users require only a subset. Furthermore, to improve usability and speed of use, the user interface can be optimized to show most likely codes first (e.g., most frequently or most recently used).

Domain Data 334 contains all relevant medical codes, such as billing codes 336, procedure codes 338, diagnosis codes 340. From the collection of codes, the relevant codes are applied to a specific encounter 310.

Patient Data contains DMG information with medical codes and notes needed for billing, as well as the current status of billing for each active patient.

User Data 302 contains administrative settings 304, user preferences 306, and usage profile 308—usage patterns capturing frequency of use and correlation between different medical codes used across different patients.

All information stored locally on the Mobile Client device is dynamically backed-up to the Cloud Server and/or Office Server, depending on the current connectivity of the Mobile Client.

Various decoding means are also included in the mobile client. For example, a Barcode Reader 204 component controls camera to capture image of a barcode and then use digital image processing to decode the barcode.

If a handheld has a dedicated barcode scanner 206, the Barcode Scanner component will control it and read its output.

A PDA Desktop Sync component 208 supports syncing data between the Mobile Client device and a computer (e.g., desktop or laptop) running a Desktop Client connected to the Office Server. It allows syncing Mobile Client via a short-range wireless connection (e.g., Bluetooth) or USB or similar wired connection instead of using long-range wireless connection. While preferred embodiment of a mobile client uses a mobile device with wireless connectivity, this component enables Mobile Clients to be used with devices that do not have wireless capability at all or when their wireless connectivity is not functioning (e.g., due to poor reception or a malfunctioning phone modem). Such clients would allow users to collect information in a stand alone mode (without real-time connectivity to the Cloud Server or Office Server) and sync up when connected to a desktop client via PDA Desktop Sync component.

The Office Server Interface component 212 supports data exchange and receiving updates from the Office Server. Typically, Office Server communicates with Mobile Clients connected to the local network (e.g., WiFi connection to office intranet), and the Cloud Server communicates with Mobile Clients that are or on public internet connected via WiFi or wireless phone modem. If Office Server needs to push data to a Mobile Client that is not on the local intranet, it can do so via the Cloud Server.

The Cloud Server Interface component 214 supports data exchange and receiving updates from the Cloud Server.

Mobile Client that has access to internet—regardless of whether it is on local (office) intranet or public internet—can connect to the Cloud Server. Typically, Mobile Client communicates with Office Server if it is connected to the same local network (e.g., WiFi connection to office intranet where Office Server is deployed). Mobile Clients that are on public internet (whether connected via Wi-Fi or wireless phone modem) communicate with Cloud Server. If Office Server needs to push data to a Mobile Client that is not on its local intranet, it can do so via the Cloud Server.

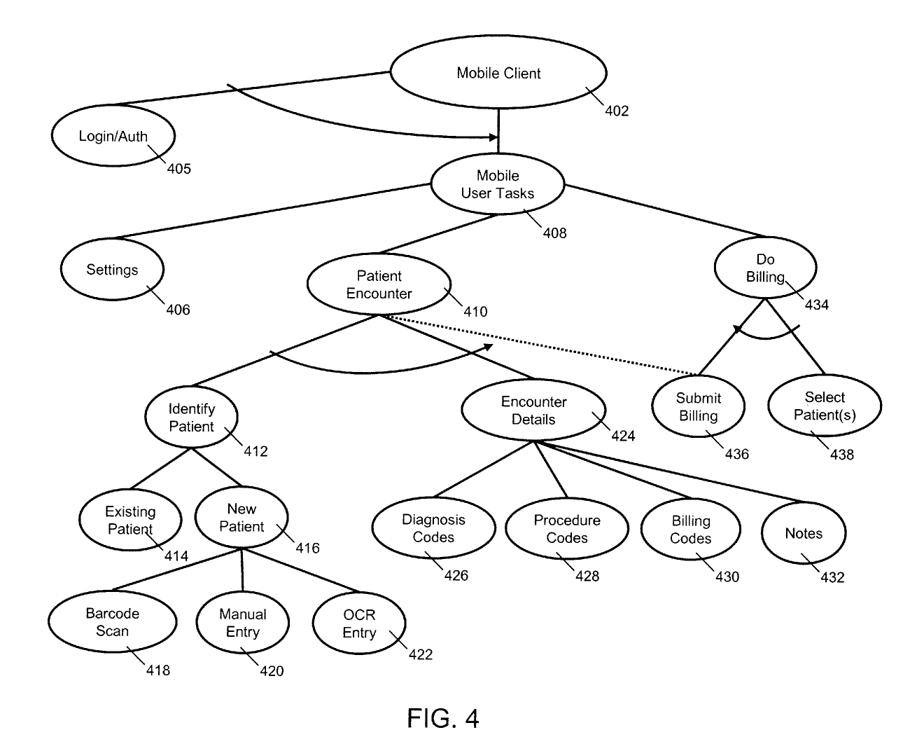

The Human Interface component 216 manages user interface for all user tasks that Mobile Client supports. A look and feel of user interface may vary across different platforms (mobile devices), but they all implement the same high-level task model shown in FIG. 4. Note that the model shows hierarchical decomposition of tasks into subtasks and main dependencies between tasks. Arrows indicate dependencies between subtasks of a given task (e.g., a patient must be identified before encounter details can be entered). If there is no arrow shown, a user can perform subtasks in any other. If a subtasks is connected via dotted line, it is optional (i.e., a user can complete a higher level task without explicitly completing its optional subtasks).

Some of the high-level task examples of mobile client 402 shown in FIG. 4 are:

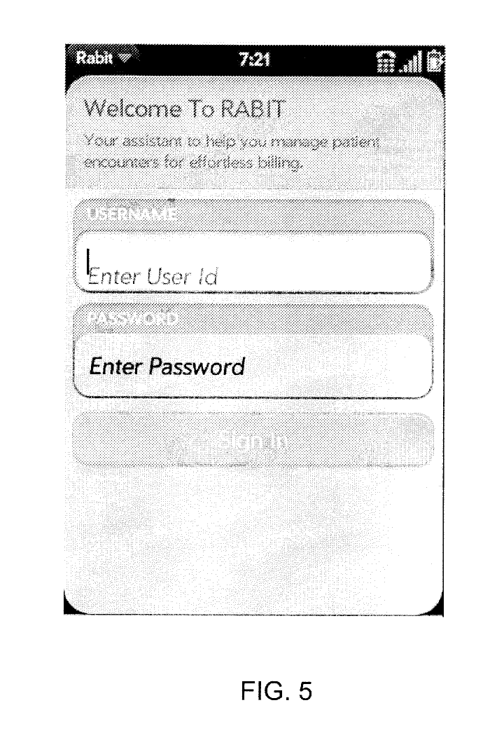

Login/Auth (405)—User Login and Authentication. Before using the system, a user must be authenticated. This may require explicit login by a user who must provide a valid user ID and password (e.g., see FIG. 5), or the solution can be configured to use security features of the underlying personal mobile device. For instance, if a personal handheld device can be locked to prevent unauthorized use and requires a secure password or personal identification number (PIN) or biometrics (e.g., finger print) to unlock, then Mobile Client can be configured to use implicit authentication.

Mobile User Tasks (408)—These are the core tasks that a Mobile Client user may perform once authenticated. Some example core tasks are:

Settings (406)—Manages preferences (e.g., how to present diagnosis/procedure/billing codes) and admin settings (e.g., connectivity and security preferences) for support staff.

Patient Encounter (410)—Allows the healthcare professional to identify a patient and provide all relevant encounter details required for billing. Optionally, notes to capture additional observations and comments can be supported too. More detailed discussion of these two sub-tasks are provided below. At the end of encounter, a healthcare professional can submit billing information, or can do it later as part of “Do Billing” task 434.

Do Billing (434)—Once the relevant information about a patient encounter is captured, a user (healthcare professional) can do billing. More detailed discussion of this task is provided below.

One of the tasks may be “Identify Patient (412).” A healthcare professional must identify a patient before entering details about an encounter. If the patient is “Existing” (414), i.e., already exists in the system and all demographic data is already uploaded to the Mobile Client, the healthcare professional can simply select from a list of existing patients. If the patient is “new” (416) and does not already exist in the system, it must be created first. The user can do it in one of three ways:

If the patient's chart has barcode and the Mobile Client device has a functioning camera (or barcode scanner), the healthcare professional can simply scan the barcode (task 418) and the Mobile Client will get patient data from Cloud Server (to be discussed in more details in the context of Cloud Server).

A user can type the patient's name and the relevant demographics information manually also (task 420). If the information entered is incomplete (e.g., the chart does not contain all demographics information that may be required for billing, or a healthcare professional does not have time to do it), an entry for the patient will be created with the information provided, and it can be completed later. The billing may not be done if information is incomplete, but the healthcare professional will be able to enter encounter details so they will not get lost. The missing information can be added later by a healthcare professional or by the practitioner's support staff via the Office Server.

If barcode on the patient's chart is not legible or is absent, a user can scan the whole chart, take the image and the Mobile Client will send it to the Cloud Server to parse the image and extract information using OCR (Optical Character Recognition). This is task 422. The Mobile Client will create a new entry using data returned from the Cloud Server. The user can validate data (to make sure OCR correctly recognized all relevant entries) and correct them as necessary.

Note that Barcode scan is typically more reliable than OCR Scan. While users may always check and correct information returned from the Cloud Server, it is more important to do so after OCR scan. By default, the user will be reminded to validate information after OCR, but not after barcode scan. This is configurable—it can be enforced or made optional by user interface, depending on selected settings.

Another example task may be termed “Encounter Details” (task 424).

The key information a healthcare professional needs to document about each encounter includes entering Diagnosis Codes 426, Procedure Codes 428 and Billing Codes 430.

In addition, a healthcare professional can optionally capture notes (task 432) to provide any additional information deemed relevant beyond entering codes. Notes can be entered as text, dictated (audio notes), or as images taken with a built-in camera.

The relevant codes (i.e., diagnosis codes, procedure and billing codes) are preloaded based on healthcare professionals specialty. A healthcare professional can select a desired code from a menu, or can search for a code by typing a search string. The Mobile Client will filter the list of all codes based on the search string. A healthcare professional can expand the search string until the list is short enough and desired code is recognized. At any point, a healthcare professional can scroll the list of (filtered) codes and select a desired code, if found. Codes can also be bundled—a healthcare professional can select a single code for a combination that occurs frequently, and the system will populate all bundled codes.

Mobile Client can do several optimizations to improve and accelerate the code selection task, such as, keeping track of most recently used (MRU) and most frequently used (MFU) codes. Based on selected preferences, a list of codes can be organized based on a default order (e.g., alphabetical or numerical order), hierarchical order based on standard categories, based on MRU, based on MFU, or a combination. For instance, a combination might show a preselected (based on preferences) number of MRU or MFU items, followed by a default order.

Another option is keeping track of correlation between codes used. Based on already provided diagnosis or procedure codes, Mobile Client will offer billing codes that are most likely to be used (e.g., offering MFU codes for a given combination of diagnosis and procedure codes).

The mobile devices typically have enough memory to fit all required information. In unlikely case that memory is insufficient, the Mobile Client can overcome the memory capacity issues as long as there is connectivity to the Cloud Server. Examples are:

Pre-loaded code limitation: If the memory limits how many codes can be pre-loaded on the mobile device, when desired codes are not found on the device, they can be dynamically fetched from the Cloud Server.

Pre-loaded patient information: The memory requirements for storing basic patient information are minimal (name and basic demographics information) and should not pose a problem. In case additional information is required (e.g., historical data and notes, which may include images), it can be dynamically updated from the Cloud Server when needed. Also, the list of patients kept on a device can be limited to “active” patients (those with scheduled appointments and with encounters not billed yet).

Capturing new information: Typically, information captured by the Mobile Client has minimal memory requirements (e.g., storing entered diagnosis, procedure and billing codes), but storing large number of notes can significantly increase these requirements. Text notes typically do not require large memory, but dictations and images may. If memory is limited, memory intensive notes can be deleted after being cached at the Cloud Server. All data stored locally on the Mobile Client are always dynamically backed up to the Cloud Server (or Office Server, depending on the connectivity) and can be retrieved when needed. For instance, if the currently selected patient has additional information on the Cloud Server, it will be proactively fetched and stored locally for later use.

A further task can be: “Do Billing.” (task 434).

This task may involve two example subtasks:

Select Patient(s) subtask 438)—a user (healthcare professional) will select one or more patients for whom there is all required billing information (i.e., all necessary information is provided), but haven't been submitted for billing yet. The patients for whom information is incomplete (e.g., missing demographics or no billing code), or who are already submitted are “disabled” to prevent selection by mistake.

Submit Billing (subtask 436)—once there is one or more patients selected, the user can submit them for billing.

Note that the system may have the option to prevent selecting patients with incomplete information or those who are already submitted for billing. Such patients are “disabled” for this particular subtask and cannot be selected for billing task. This reduces billing errors and rejections. However, it may or may not prevent errors where the healthcare professional does not include all applicable codes. The benefit of entering information right after the encounter is that such omissions will be less likely. In case a healthcare professional submits a patient for billing and later needs to add more codes (e.g., additional encounter during the same day), supports such a scenario. A user can update encounter details (e.g., add additional codes) for a patient that is already submitted for billing. In that case, it will be re-enabled and can be selected for billing and submitted again with the updated information.

Note that the “Submit Billing” subtask is part of two higher-level tasks: “Do Billing” and “Patient Encounter”. If done as part of the later, it applies to the currently selected patient whose encounter has been updated.

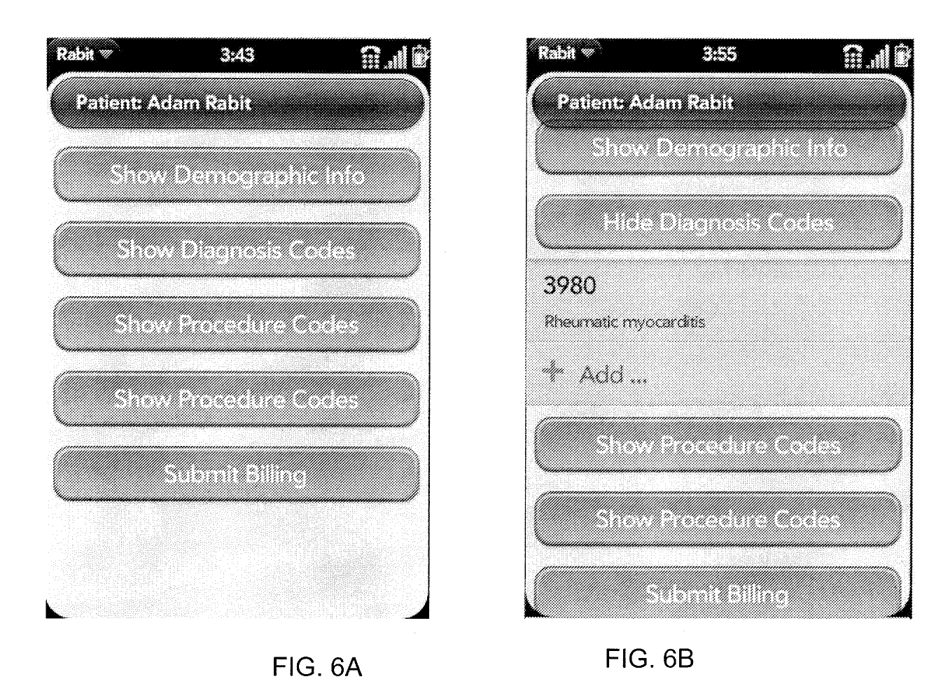

Once the patient encounter is documented, a healthcare professional can immediately submit it to a Billing Service as part of “patient Encounter” task. This is expected to be the most likely usage scenario where healthcare professionals bill right after their service is rendered, avoiding any delays. FIGS. 6A-6B correspond to this scenario and show screens for “Patient Encounter” task with “Submit Billing” option enabled. Note that the screenshots in FIGS. 5 and 6A-6B are taken of Palm Pre implementation of Rabit Mobile Client by Rabit Solution of Pittsburg, Pennsylvania. Different platforms may have different look and feel. The “Submit Billing” option is enabled once all required information is provided. Healthcare professional can go back to review and update information before submitting it. FIG. 6B shows an example where healthcare professional selected “Show Diagnosis Codes” in the screen on FIG. 6A to review and potentially update the codes already entered, or add new ones. The same can be done for other information.

Alternatively, the healthcare professional can wait (e.g., if the healthcare professional expects to have multiple encounters with the same patient in the same day) and submit billing at a later time. The healthcare professionals can also submit “batch” billing for multiple patients at once as part of the “Do Billing” task.

There can be many variations of the User Interface.

User interactions described and screen shots shown herein are meant as illustration and not as the only way to interact with and perform the user tasks it supports. The task model shown in FIG. 4 can be mapped to many different user interface instantiations, each with a different look and feel. Each platform can have a different look and feel (e.g., to accommodate different interaction capabilities, such as a touch screen vs. scroll wheel pointing device; whether there is a physical keyboard or virtual only; screen size etc. Even on the same platform, it is possible to make transformations such as, making a task optional (i.e., a user may perform it, but does not have to), or, making a task explicit/implicit.

For example, the subtask “Submit Billing” can be made optional by default (shown with dotted connection to the “Patient Encounter” task in the task model), so a healthcare professional can delay the billing until later, i.e., skip the billing, move on to another patient encounter, possibly update encounter details later, and do a batch billing at the end of a day. However, if a healthcare professional finds that there is never a need to update the encounter information and too often the billing is unreasonably delayed because the end of a day is too hectic, the user interface can be transformed to make the subtask “Submit Billing” required instead of optional.

Similarly, the “Login/Auth” task can be made explicit (that is a default shown in the task model), or implicit. If it is explicit, the user can not start “Mobile User Tasks” until after “Login/Auth” task is successfully completed. If it is made implicit, the user does not have to explicitly perform “Login/Auth” task and user credentials are retrieved from elsewhere.

The Mobile Client Services component coordinates all other Mobile Client components. It also performs the additional supporting services, such as Authorization and Security, Manage preferences, Notifications, Backups and memory management.

Depending on selected preferences, Mobile Client may require explicit user authentication (user must login with valid ID and password), or may rely on a device's security mechanism. For instance, a secure device may require that a user must unlock a device with a valid PIN or password before every use, regardless of what application the user intends to access. In such a case, explicit login to Mobile Client can be made optional. One of the options is to require explicit login the first time is used during the day, or whenever a certain period (e.g., 30 minutes) has passed since the last use. This depends on user preferences and institutional security policies (e.g., hospital).

Regardless of whether explicit login is required or not, a user must have a valid ID and password. The authentication required to use the Mobile Client involves two steps:

Local authentication to give a user access to local functionality.

Global authentication to give Mobile Client access to Office Server and Cloud Server. No data will be exchanged between a Mobile Client and (Office or Cloud) Servers unless the Client's user is properly authenticated.

Each user has a profile associated with the user's ID. Once a user is authenticated, the system will know what data are associated with the user (e.g., what patient, what specialty codes), what billing service to use and other preferences.

On attempted unauthorized access (e.g., repeated wrong login or failure to unlock the device), this service will clear all data. Since all data is backed up to Servers, there is no loss of data and it reduces the risk of unauthorized data access.

If a device is damaged and not working, a user can switch to a new device easily and have access to all user's data that are backed up on Servers.

If a device is transferred to another person, or is lost or stolen, a user can similarly switch to a new device, plus the old device can be flagged to clear all data and disable the Mobile Client on the old device.

Based on selected preferences, the service schedules data backups and updates. It also ensures that there is enough memory by selecting items to clear from local memory and retrieve from Servers as needed.

The ‘Notification’ service, together with the corresponding service on servers, checks all data for various conditions and manages reminders. For example, it will notify a healthcare professional if there are patient encounters that are not yet submitted for billing, scheduled patients without documented encounters, status of pending bills.

The ‘Manage Preferences’ service manages all user preferences and configures interaction between different components accordingly.

### Office Server

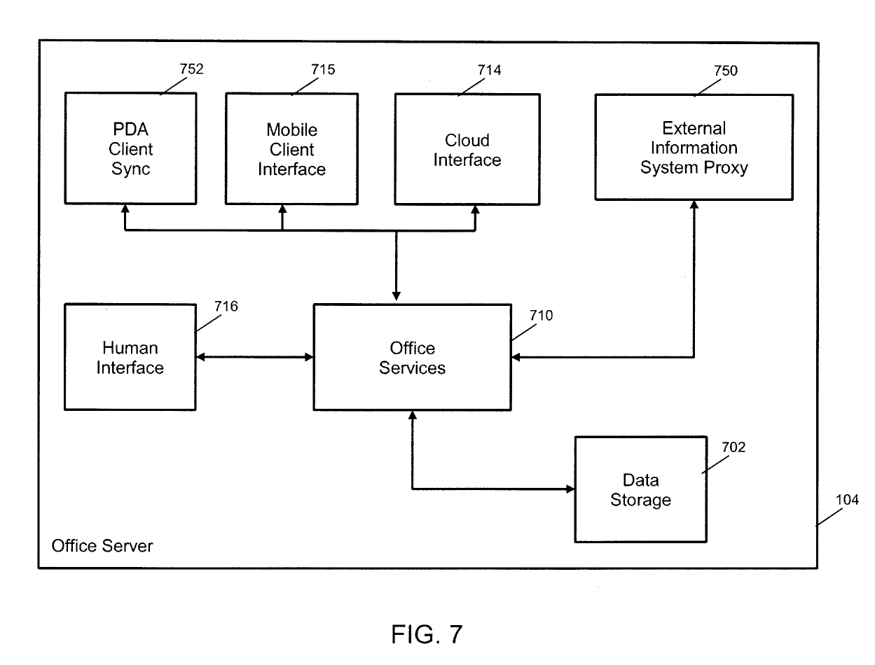

The Office Server is typically deployed on a local network (intranet) in a healthcare professional office/practice, where other systems for the practice are deployed, such as EMR, scheduling and practice management systems. It is also possible to deploy the Office Server remotely, as a virtual server in the “Cloud”. For instance, it is possible to co-locate it with the Cloud Server and access its functionality as a service (e.g., SaaS—Software as a Service). This scenario is likely for practices that use other systems (e.g., practice management etc.) using SaaS model. FIG. 7 shows main components of the Office Server 104.

Data Storage 702 is a local storage where Office Server keeps information about active patients, relevant domain and specialty-specific information (such as, diagnosis, procedure and billing codes), usage profiles and user preferences. It is a superset of the information stored in Mobile Client Data Storage—it contains all the information stored in the Mobile Clients belonging to the same practice as the Office Server, plus information about healthcare professionals associated with each Mobile Client. Various example Office Services 710 are described below.

The PDA Client Sync component 752 is counterpart to PDA Desktop Sync component of the Mobile Client. It supports syncing data between a Mobile Client device and the Office Server via a computer (e.g., desktop or laptop) running the PDA Client Sync component. If the Office Server is deployed remotely (in the “cloud”), this component will be downloaded and run on-demand on a desktop computer used for syncing.

The Mobile Client Interface component 715 is counterpart to Office Server Interface component of the Mobile Client. It supports communication and data exchange with the Mobile Client.

The Cloud Interface component 714 supports communication and data exchange with the Cloud Server.

The External Information System Proxy component 750 supports communication and data exchange with external information management systems (IMS) that store and manage information for healthcare professional's office/practice, such as EMR or Practice Management Systems. There is a proxy component for each external system from which Office Server needs to receive information, such as patient demographic information and encounter schedules. Each proxy component is configured to “understand” the communication protocol and data mappings for a specific external IMS.

If the practice does not use external IMS, or use systems that do not provide interface for exchanging information, the patient demographic information can be obtained by other means, e.g., direct input into Office Server by practitioner's staff via Human Interface component, or scanning patient chart and importing via OCR, or barcode scanning and importing via Cloud Server from other external IMS.

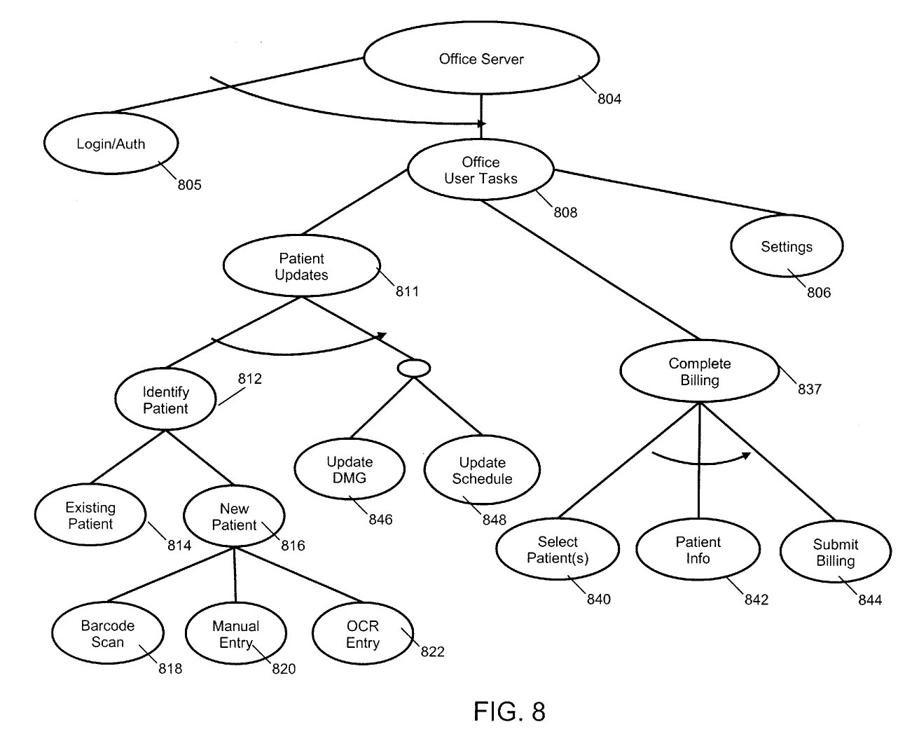

The Human Interface component 716 manages user interface for all user tasks that Office Server supports. A primary user role interacting with Office Server via this interface is not a healthcare professional, but his/her staff or office admin. The high-level task model is shown in FIG. 8.

Some of the high-level tasks by the office server 804 in FIG. 8 are:

Login/Auth (805)—User Login and Authentication. Before using the system, a user must be authenticated.

Office User Tasks (808)—these are the core tasks that an Office Server user may perform once authenticated. Some of the core tasks may include:

Settings (806)—Manage preferences and admin settings (e.g., connectivity and security preferences)

Patient Updates (811)—This task allows a user to update relevant information about patients. This information is typically imported from external Office/Practice IMS (Information Management Systems). If some of the information is missing, the office staff can update it. More detailed discussion of this task is provided below.

Complete Billing (837)—If a healthcare professional could not complete billing because of missing information (e.g., incomplete demographic information or outdated payer info), a user here can update relevant info and (re)submit the bill. This task may have example subtasks of select patients (840), verify patient information (842), and submit billing (844).

We describe the task “Patient Updates” (811) in further detail as an example.

The patients' information is typically imported from external Office/Practice IMS (Information Management Systems). This task supports updating inaccurate information and providing missing information, e.g., incomplete demographic information, outdated payer information, or scheduling information. There are some example subtasks:

Identify Patient (subtask 812)—Select an existing patient or create a new entry. When entering a new patient (subtask 816), there are various possible way, including the examples below:

Barcode Scan (subtask 818)—A user (e.g., office staff) can scan a patient chart that has barcode and retrieve information from the Cloud Server. For instance, this scenario may start when a hospital schedules an encounter with a patient and submits to a healthcare professional's office a chart with barcode. The Cloud Server will retrieve relevant information from the corresponding hospital IMS and provide it to Office Server. This scenario avoids unnecessary data entry and minimizes typos and similar errors.

OCR Entry (subtask 822)—A user scans a patient's chart and extracts information via OCR Service. The actual OCR Service is managed by the Cloud Server, but that is transparent to the user.

Manual Entry(subtask 820)—A user enters patient information manually. For instance, this scenario is likely if a patient provides the information verbally or via handwritten form in the healthcare professional office, or any other situation where the other two options are not available or less practical then the manual entry.

Another part of the “Patient Update” task is “Update DMG” (subtask 846) i.e., to verify and update demographic information, if needed.

Another part of “Patient Update” task is “Update Schedule” (subtask 848), i.e. to verify and update information about the next scheduled encounter, if needed.

The task model shown in FIG. 8 can be mapped to many different user interface instantiations, each with a different look and feel. Besides variations across different platforms (e.g., to accommodate different form factors and interaction capabilities), it is also possible to vary look and feel of a user interface to accommodate different user preferences. As discussed earlier, this can be accomplished by applying transformations to change look and feel of a user interface implementing a given task model.

The Office Services component coordinates all other Office Server components. It also performs the additional supporting services, such as, Authorization and Security, Managing preferences, and Notifications etc.

The Authorization and Security service authenticates users and ensures that only authorized users can access Office Server. This applies to users accessing Office Server directly via Human Interface component, or Mobile Clients users. In the latter case, when there is a request from a Mobile Client, this service will validate whether its user is authorized to access services.

The ‘Notifications’ service, together with the corresponding service on the Cloud Server, checks all data for various conditions and manages reminders. For example, based on selected preferences, it will notify users if there are patient encounters that are not yet submitted for billing, scheduled patients without documented encounters, status of pending bills. It can notify multiple users about a relevant event. For instance, it can notify both a healthcare professional and an office staff supporting that healthcare professional if there is an encounter not billed yet, or if there is a pending bill requiring more information.

The ‘Manage Preferences’ service manages all user preferences and configures interaction between different components accordingly.

### Cloud Server

The Cloud Service gathers and stores all relevant data that users may need. This information includes billing codes, procedural and diagnosis codes, as well as DMG (demographic) information for “active” patients). Cloud Service provides interfaces to external third-party systems: hospital information management systems (HIMS) and Billing Systems. Cloud also provides services that may not be supported on a particular handheld where Mobile Client is running, such as a bar-code reader. For instance, Mobile Client can scan the patient barcode using handheld's camera. Typically, the Mobile Client will process the barcode locally, but if it fails (e.g., noisy image or a handheld without a compatible local barcode processing service), it can send the image to the Cloud Service and have it processed there.

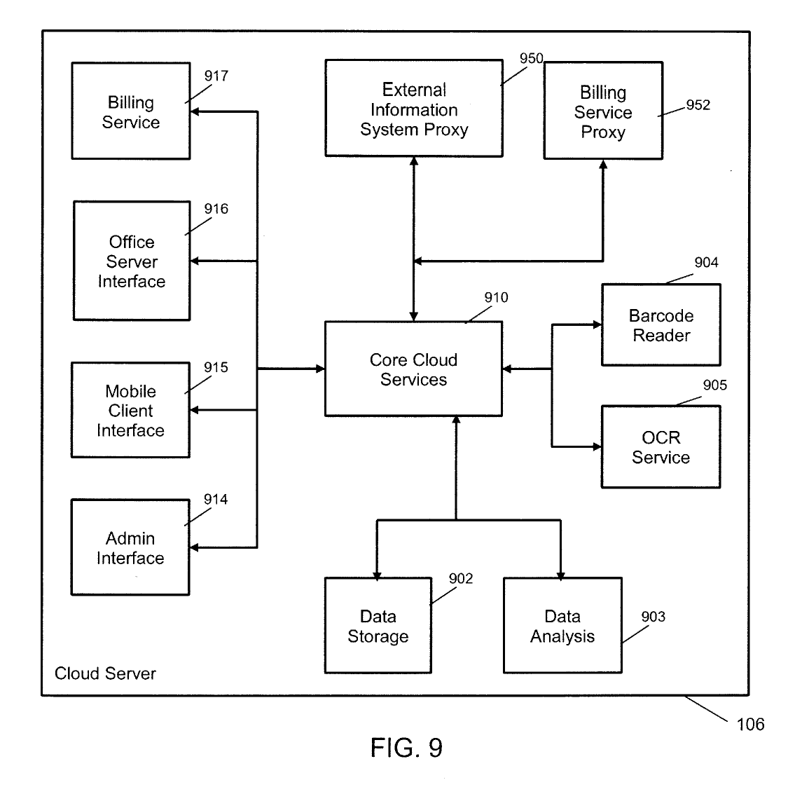

FIG. 9 shows main components of the Cloud Server 106, offering various core cloud services 910.

Data Storage 902 is the main storage where Cloud Server keeps information about active patients, relevant domain and specialty-specific information (such as diagnosis, procedure and billing codes), usage profiles and user preferences. It is a superset of the information stored in the Mobile Client Data Storage and the Office Server Data Storage—it contains all information stored in Office Servers (which is in turn superset of the information stored in the Mobile Clients), plus information about healthcare professionals and practices associated with each Office Server.

Data Analysis service 903 performs data mining and analysis. It checks all data for various conditions and manages reminders in coordination with corresponding services on Mobile Clients and Office Servers. For instance, it will detect and notify users if there are patient encounters that are not yet submitted for billing, scheduled patients without documented encounters, and if the status of a pending bill requires further action.

It can also correlate data across all users (all healthcare professionals managing their encounters and billing using) to identify and recognize patterns, such as billing patterns across specialties, geographical regions, patient types, seasonal factors. While all aggregate data is “cleansed” to remove any personally identifiable information, the observed patterns can be used to compare what individual healthcare professionals are doing relative to their control group and provide them with individualized feedback.

The ‘Billing Service’ component 917 handles billing and is an alternative to using a third party billing service via Billing Service Proxy.

The Office Server Interface component 916 is counterpart to Cloud Interface component of the Office Server. It supports communication and data exchange with the Office Service.

The Mobile Client Interface component 915 is counterpart to Cloud Server Interface component of the Mobile Client. It supports communication and data exchange with the Mobile Client.

The Admin Interface component 914 manages user interface for all administrative tasks for managing and configuring components.

The External Information System Proxy component 950 supports communication and data exchange with external information management systems (IMS) that store and manage patient information, such as EMR or other Hospital IMS Systems. There is a proxy component for each external system from which Cloud Server needs to receive information, such as patient demographic information. Each proxy component is configured to “understand” the communication protocol and data mappings for a specific external IMS.

The Cloud Server may not directly interface with IMS systems belonging to individual healthcare professional practices, but can do so indirectly—via an Office Server. If a healthcare professional's practice uses an IMS that can provide required patient information, Office Server will be able to access it and pass it on to the Cloud Server.

The Billing Service Proxy component 952 supports communication and data exchange with external Billing Service systems.

The Barcode Reader component 904 uses digital image processing to decode the barcode it receives from Mobile Clients or Office Servers.

The OCR Service component 905 extracts patient information from document images. It turns patient chart document image into a structured DMG (demographics) information. For instance, it recognizes fields on a patient chart form and extracts corresponding information, such as patient name, account number, data of birth, etc.

### Collaborative Workflow and Billing Support Configuration

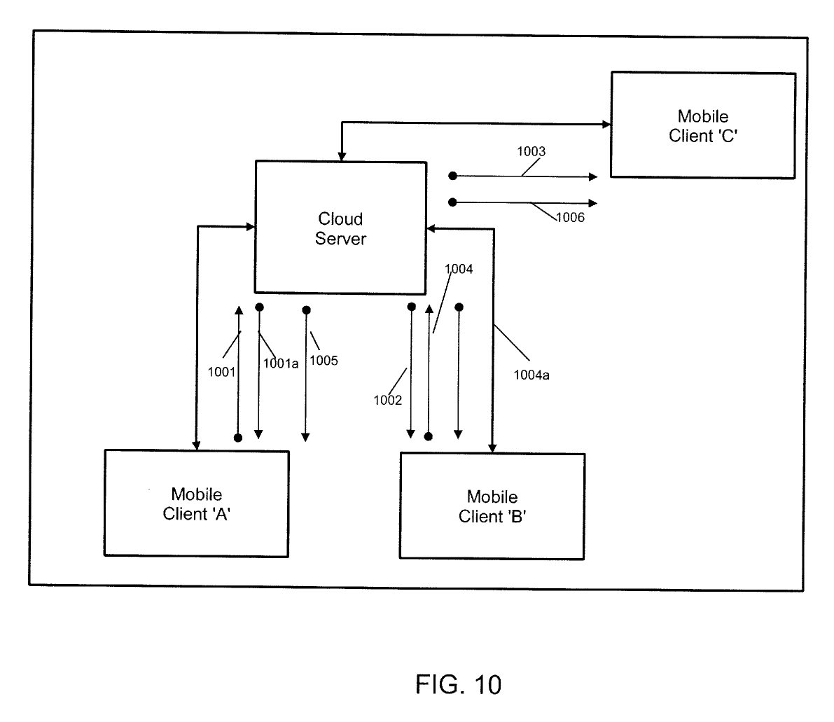

Mobile clients described in the description above can communicate with each other to facilitate seamless collaboration between users belonging to the same group. It is seamless, because users do not have to make extra effort to share information. FIG. 10 shows one possible embodiments of such collaborative support configuration. For simplicity, FIG. 10 shows three mobile clients (A, B, and C), but this can be applied to any number of mobile clients belonging to users (i.e. healthcare professionals) who belong to the same group and are authorized to share relevant information. All data on each mobile client that user inputs by any of the available data capturing devices is communicated to the server. The server processes such data and communicates with the mobile clients any additional relevant data that result from such processing (e.g., updated status of the billing request previously submitted or OCR processed demographic information for a patient, or results of the requested procedures). These data are communicated to all mobile clients belonging to the same group of healthcare practitioners who are subscribed to and authorized to receive such information. Individual users can control who has access to their information updates and can subscribe to updates made by others. Typically, users within the same group will have such authorizations. As a result, users of mobile clients belonging to the same group can communicate with each other, passing relevant information and collaboratively providing care to the patients while avoiding redundant work (e.g., if one healthcare professional sees a patient, others in his/her group will know that). The example shown in FIG. 10 reflects the following scenario: Mobile Client ‘A’ captures new data and communicates this to a server (arrow 1001). The cloud server communicates updated data to Mobile client ‘A’ (arrow 1001 a) and then to other Mobile Clients in the same group (arrows 1002 and 1003). Next, another mobile Client (‘B’) captures new data and communicates it to the server (arrow 1004). The server communicates updated data to Mobile Client ‘B’ and then to other clients (arrows 1005 and 1006). This way the team workflow and overall efficiency can be increased, because redundant work is avoided, and actionable knowledge is shared between collaborators. The sharing can be triggered automatically or can be controlled by users.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A system comprising:
one or more servers adapted to communicate with one or more front-end clients connected via a computer or telephone network;
one or more data repositories adapted to store and provide information that is categorically coded and is accessed and updated on-demand by the one or more front-end clients; and
one or more data inputting means included in the one or more front-end clients, wherein inputted data is associated with the categorically coded information; and
one or more data decoding means to decode the categorically coded information.

2. The system according to claim 1, wherein the one or more servers include a office server located in a primary place of business, and a cloud server that is remotely located from a primary place of business.

3. The system of claim 1, wherein the front-end client includes one or more of a mobile client, and a web-based client.

4. The system according to claim 1, wherein the one or more data repositories include one or more externally hosted databases containing relevant billing-related information, the externally hosted databases being in communication with the one or more servers.

5. The system according to claim 1, wherein the data inputting means include one or more of a camera, a barcode scanner, a touch pad, a virtual note pad, an audio recorder, and an image scanner.

6. The system according to claim 1, wherein the data decoding means are located in the front-end client or in the one or more servers.

7. The system according to claim 1, wherein the categorically coded information is decoded by the data decoding means using a digital image processing technique.

8. The system according to claim 7, wherein the digital image processing technique comprises one or more of barcode reading and optical character recognition (OCR) techniques.

9. The system according to claim 1, wherein categories of coding information include: diagnosis codes, procedure codes, and billing codes.

10. The system according to claim 1, wherein the front-end client is configured to quickly retrieve data selectively stored at a local memory of a device where the front-end client is installed.

11. The system according to claim 10, wherein selectively stored data comprise one or more of: active patient demographic data, medical insurance data, diagnosis data, procedural data, current patient encounter data, patient encounter records for the last ‘N’ days (where N is an integer), historical usage data, or a relevant combination thereof.

12. The system according to claim 11, wherein the front-end client is configured to associate one or more of the selectively stored data to appropriate billing codes.

13. The system according to claim 12, wherein once all desired billing codes are associated, the front-end client communicates with an externally hosted billing server to instruct generation and processing of a billing statement.

14. The system according to claim 1, wherein the one or more servers are configured to communicate collaborative data inputted or updated by one of the front-end clients to the other front-end clients coupled to the server.

15. A method for expediting coding and billing workflow using a mobile device, the method comprising:
executing a mobile client on the mobile device for managing inflow and outflow of information;
capturing categorically coded information by a data capturing means coupled to a mobile device;
decoding the categorically coded information by using a digital image processing technique locally on a mobile device or by communicating with one or more servers in communication with the mobile client via a computer or telephone network;
selectively storing relevant data in a local memory of the mobile device, wherein the servers store or channel the categorically coded information;
associating the selectively stored data from the mobile device's local memory to the decoded information;
associating appropriate billing codes to service performed during a patient encounter based on the decoded information; and
sending instructions to a billing server to generate and process a billing statement.

16. The method according to claim 15, wherein the one or more servers include a office server located in a primary place of business, and a cloud server that is remotely located from a primary place of business.

17. The system according to claim 15, wherein the data capturing means one or more of a camera, a barcode scanner, a touch pad, a virtual note pad, an audio recorder, and an image scanner.

18. The method according to claim 15, wherein the digital image processing technique comprises one or more of barcode reading and optical character recognition (OCR) technique.

19. The method of according to claim 15, wherein the selectively stored relevant data comprise one or more of: active patient demographic data, medical insurance data, diagnosis data, procedural data, current patient encounter data, patient encounter records for the last ‘N’ days (where N is an integer), historical usage data, or a relevant combination thereof.

20. A method of providing an interface for medical information management using a mobile device, the method comprising:
executing a mobile client on the mobile device for managing inflow and outflow of medical information;
during an encounter with a patient, identifying the patient;
retrieving relevant medical data for the patient from one or more servers in communication with the mobile client through respective server interfaces;
entering diagnosis codes, procedure codes, and billing codes associated with the services provided during the encounter;
submitting billing instructions to an externally hosted billing server via the one or more servers in communication with the mobile client.

21. A method for optimizing coding practices, the method comprising:
collecting and analyzing historical usage data to compare current and past coding practices for an individual healthcare professional or a group of healthcare professionals;
determining effectiveness of a current coding practice relative to the past coding practice; and
comparing current coding practices with coding practices of other healthcare professionals.

22. The method of claim 21 that categorizes healthcare professionals based on their specialty, geographical regions, patient types, seasonal and other factors to identify a control group for a given healthcare professional and to compare their usage patterns with respect to the control group.

23. The method of claim 21 that uses the historical usage data to identify codes that typically occur together and to make suggestions to the healthcare professionals about potentially missing or incorrect codes.
